(19) United States
(12) Patent Application Publication
(10) Pub. No.: US 2010/0107911 A1
(43) Pub. Date: May 6, 2010

(54) Printing Unit of a Printing Press

(75) Inventors: Georg Schmid, Neusaess (DE); Josef Singler, Binswangen (DE)

Correspondence Address: COHEN, PONTANI, LIEBERMAN & PAVANE LLP, 551 FIFTH AVENUE, SUITE 1210, NEW YORK, NY, 10176, US

(73) Assignee: manroland AG, Offenbach am Main (DE)

(21) Appl. No.: 12/433,018

(22) Filed: Apr. 30, 2009

(30) Foreign Application Priority Data
May 15, 2008 (DE) 10 2008 023 716.7

(51) Int. Cl. B41F 5/00

(52) U.S. Cl. 101/216

(57) ABSTRACT

A printing unit of a printing press has at least one printing couple including a form cylinder, a transfer cylinder, an inking couple, and possibly a dampening unit; wherein the circumference of the transfer cylinder is a whole-number multiple of the circumference of the form cylinder; an impression cylinder cooperates with the transfer cylinder of the printing to form a nip, through which a substrate to be printed can be conveyed; and intermeshing drive gears are assigned to the form cylinder and to the transfer cylinder. The inking couple can be driven by the transfer cylinder of the printing couple by way of intermeshing drive gears in such a way that the drive connection between the transfer cylinder and the inking couple of the printing couple is independent of the drive connection between the transfer cylinder and the form cylinder.

### BACKGROUND OF THE INVENTION

1. Field of the Invention

The invention pertains to a printing unit having at least one printing couple, each printing couple including a form cylinder, a transfer cylinder, and an inking couple, the transfer cylinder having a circumference which is a whole-number multiple of the circumference of the form cylinder; an impression cylinder cooperating with the form cylinder to form a nip through which a substrate to be printed can be fed; and a drive connection between the transfer cylinder and the form cylinder.

2. Description of the Related Art

Printing units of web-fed printing presses known from practice have several printing couples, where each printing couple comprises a transfer cylinder, a form cylinder, an inking couple, and possibly a dampening unit. Form cylinders are also called plate cylinders, and transfer cylinders are also called blanket cylinders. An impression cylinder works together with the transfer cylinder or blanket cylinder of a printing couple to form a nip for the substrate to be printed, where the impression cylinder can be a satellite cylinder or a transfer cylinder or blanket cylinder of an adjacent printing couple. A satellite cylinder usually cooperates with several transfer cylinders of different printing couples. In the case of sheet-fed printing presses, the impression cylinder which cooperates with the transfer cylinder of a printing couple is called a printing cylinder.

FIG. 1 shows a schematic diagram of a printing unit 10 of a web-fed printing press known from the prior art with two printing couples 11, 12 for printing both sides of a substrate web 13, where each of the two printing couples 11, 12 comprises a transfer cylinder 14, a form cylinder 15, an inking couple 16, and a dampening unit 17. In the case of the printing unit 10 of FIG. 1, therefore, the transfer cylinder 14 of the printing couple 11 forms the impression cylinder for the transfer cylinder 14 of the printing couple 12, and the transfer cylinder 14 of the printing couple 12 forms the impression cylinder for the transfer cylinder 14 of the printing couple 11.

In the printing unit 10 of FIG. 1, a drive motor 18 is assigned to the transfer cylinder 14 of the printing couple 12. This motor acts on the transfer cylinder 14 of the printing couple 12. The drive motor 18 of the printing unit 10 of FIG. 1 serves to drive the transfer cylinders 14, the form cylinders 15, the inking couples 16, and the dampening units 17 of both printing couples 11, 12, where the drive motor 18 drives these assemblies with the help of intermeshing drive gears. In FIG. 1, intermeshing drive gears are shown in broken line. Thus a drive gear assigned to the drive motor 18 drives a drive gear assigned to the transfer cylinder 14 of the printing couple 12. The drive gear of the transfer cylinder 14 of the printing couple 12 drives a drive gear assigned to the form cylinder 15 of the printing couple 12 and the drive gear assigned to the transfer cylinder 14 of the printing couple 11, where the drive gear of the transfer cylinder 14 of the printing couple 11 drives a drive gear assigned to the form cylinder 15 of the printing couple 11. According to FIG. 1, the drive gear of the form cylinder 15 of each printing couple 11, 12, acting by way of an intermediate gear 19, drives the drive gear assigned to the inking couple roller of the inking couple 16 of the associated printing couple 11, 12. The dampening unit 17 of the printing couple 11 can also be driven by additional drive gears. According to the prior art shown in FIG. 1, therefore, the inking couples 16 of the printing couples 11, 12 are driven by way of intermeshing drive gears, namely, by way of the drive gears assigned to the form cylinders 15 of the printing couples 11, 12.

In the case of the printing unit 10 of FIG. 1, the circumference of the transfer cylinder 14 in the area of each of the two printing couples 11, 12 is a whole-number multiple of the circumference of the associated form cylinder 15. The form cylinders 15 of the printing couples 11, 12 are therefore slender form cylinders 15 with a relatively small diameter and a relatively large axial dimension, as a result of which they tend to sag.

In the above-described drive connection between the inking couples 16 and the form cylinders 15 of the printing couples 11, 12 in question, there is therefore the problem that torque variations, which result from the inking couple 16 in question, can lead to elastic deformation of the journals of the form cylinders 15, on which the drive gears of the form cylinders 15 are mounted. As a result, the center points of the drive gears of the form cylinders 15 can be shifted, which ultimately leads to the occurrence of doubling on the printed product and thus to a loss of achievable print quality. The greater the axial dimension of the form cylinders 15, the greater the severity of this problem.

### SUMMARY OF THE INVENTION

Against this background, the present invention is based on the goal of creating a novel printing unit of a printing press in which better print quality can be achieved using slender form cylinders. According to the invention, the inking couple of the printing couple or of each printing couple can be driven by the transfer cylinder of the printing couple in question by way of intermeshing drive gears in such a way that the drive connection between the transfer cylinder and the inking couple of the printing couple in question is independent of the drive connection between the transfer cylinder and the form cylinder of the printing couple in question. In the inventive printing unit, the inking couple of each printing couple is therefore driven not via the form cylinder of the printing couple in question but rather by the transfer cylinder of the printing couple in question.

In the inventive printing unit, therefore, there is no mechanical drive connection via gears in the area of the printing couples between the form cylinders and the printing couples. Because the circumference of the transfer cylinder is a whole-number multiple of the circumference of the form cylinder and the transfer cylinder is therefore stiffer overall, it is possible with the present invention to avoid doubling in printing couples with slender form cylinders and thus to increase print quality.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

FIG. 1 shows a side view of a printing unit of a web-fed printing press with two printing couples as known from the prior art;

FIG. 2 shows a side view of an inventive printing unit of a web-fed printing press with two printing couples; and

FIG. 3 shows a part of the printing unit of FIG. 1 in a view rotated 90° versus FIG. 1.

### DETAILED DESCRIPTION OF THE PRESENTLY PREFERRED EMBODIMENTS

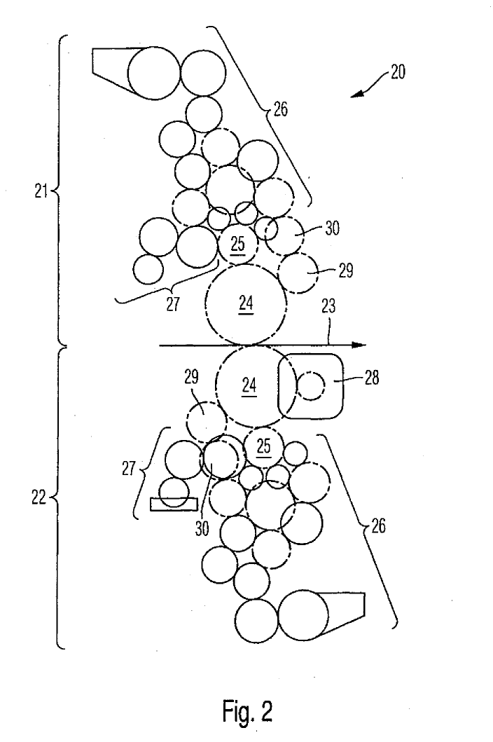

FIG. 2 shows a schematic diagram of an inventive printing unit 20 of a web-fed printing press with two printing couples 21, 22, which serve in turn to print both sides of a substrate web 23. Each of the printing couples 21, 22 of the printing unit 20 of FIG. 2 has in turn its own transfer cylinder 24, its own form cylinder 25, its own inking couple 26, and its own dampening unit 27, where the circumference of the transfer cylinder 24 is in each case a whole-number multiple of the circumference of the form cylinder 25 in question.

A drive motor 28, which drives the transfer cylinder 24 of the printing couple 22, is also assigned to the printing couple 22, where, for this purpose, intermeshing drive gears are assigned both to the drive motor 28 and to the transfer cylinder 24. As can be seen in FIG. 2, in which the drive gears are shown in broken line, the drive gear assigned to the transfer cylinder 24 of the printing couple 22 drives directly a drive gear assigned to the form cylinder 25 of the printing couple 22.

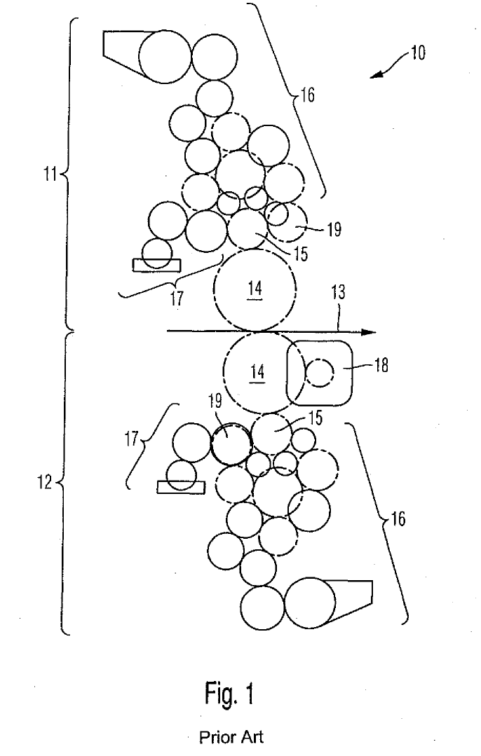

Similarly, the drive gear assigned to the transfer cylinder 24 of the printing couple 22 drives a drive gear assigned to the transfer cylinder 24 of the printing couple 21, where the drive gear of the transfer cylinder 24 of the printing couple 21 drives directly a drive gear assigned to the form cylinder 25 of the printing couple 21. To this extent the printing unit 20 FIG. 2 is the same as the printing unit 10 of FIG. 1.

In the inventive printing unit 20 of FIG. 2, each of the inking couples 26 is driven in the area of each printing couple 21, 22 by a transfer cylinder 24, which acts by way of intermeshing drive gears. For this purpose, two intermediate gears 29, 30 are provided by which the associated inking couple 26 is driven indirectly by the transfer cylinder 24. In the inventive printing unit 20, therefore, the drive connection between the transfer cylinders 24 and the inking couple 26 of the associated printing couple 21, 22 is independent of the drive connection between the transfer cylinder 24 and the form cylinder 25 of the printing couple 21, 22, however, the intermediate gear 29 and the drive gear of the form cylinder 25 both mesh with the drive gear of the associated transfer cylinder 24. As a result, torque fluctuations in the inking couple 26 are not transmitted to the relatively slender form cylinder 25 but are instead absorbed in the area of the stiff transfer cylinder 24, the circumference of which is a whole-number multiple of the circumference of the form cylinder 25.

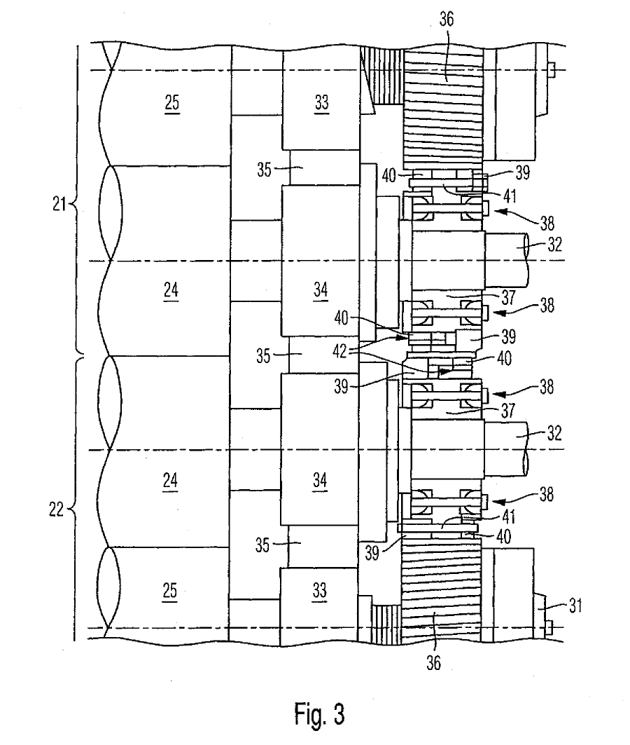

FIG. 3 shows a part of the printing unit 20 in the area of the transfer cylinder 24 and of the form cylinder 25. The form cylinder 25 and the transfer cylinder 24 are rotatably supported by their cylindrical journals 31, 32 on bearings 33, 34 in a side wall 35, as shown. On the side of the side wall 35 facing away from the cylinders 24, 25, drive gears 36, 37 are supported on the cylindrical journals 31, 32 of the form cylinder 25 and of the transfer cylinder 24.

It can thus be derived from FIG. 3 that the drive gears 36 are supported on the cylindrical journals 31 of the form cylinders 25, and that the drive gears 37 are supported on the cylindrical journals 32 of the transfer cylinders 24, where the drive gears 36, 37 of each printing couple mesh with each other.

For the drive gears 37 of the transfer cylinders 24, FIG. 3 shows by way of example that these gears are attached to the cylindrical journals 32 of the transfer cylinders 24 in question by means of clamping elements 38, which provide a torque-transmitting connection between the drive gear in question and the associated cylindrical journal.

In the area of each printing couple 21, 22, the drive gears 36 and 37 of the form cylinder 24 and of the transfer cylinder 25 mesh with each other. This intermeshing is by nature subject to backlash. The backlash, however, may not be allowed to cause any technical printing problems. To ensure that no such problems occur, an auxiliary gear 39 and preferably an adjusting disk 40 are assigned to the drive gear 37 of each transfer cylinder 24, as shown in FIG. 3. The auxiliary gear 39 has the same tooth geometry as the drive gear 37 of the transfer cylinder 24 to which the auxiliary gear 39 is assigned. The auxiliary gear 39, furthermore, like the drive gear 37 of the transfer cylinder 24, meshes with the drive gear 36 of the form cylinder 25. In the area of each printing couple 21, 22, the auxiliary gear 39 assigned to the drive gear 37 of the transfer cylinder 24 in question and the adjusting disk 40 assigned to the drive gear 37 in question are connected to the drive gear 37 by way of spring elements or flexible elements designed as flexible rods 41. These flexible rods 41 are distributed uniformly around the circumference of the drive gear 37, of the auxiliary gear 39, and of the adjusting disk 40, where the flexible rods 41 extend in the axial direction and pass through the adjusting disk 40, the auxiliary gear 39, and the drive gear 37 of the transfer cylinder 24.

According to FIG. 3, the auxiliary gear 39 is screwed to a first side of the drive gear 37 by way of the flexible rods 41. The adjusting disk 40, however, is screwed to the second side of the drive gear 37 by way of the flexible rods 41. The auxiliary gear 39 and the adjusting disk 40 therefore act on opposite sides of the drive gear 37 in question.

By rotating the adjusting disk 40 in the circumferential direction with respect to the drive gear 37 of the transfer cylinder 24, the auxiliary gear 39 can be rotated with respect to the drive gear 37 of that transfer cylinder 24. The rotation of the adjusting disk 40 versus the drive gear 37 in question and thus the rotation of the auxiliary gear 39 versus that drive gear takes place in such a way that, when, on the one hand, the drive gears 37, 36 mesh and, on the other hand/end, the auxiliary gear 39 assigned to the drive gear 37 meshes with the drive gear 36, the driving tooth flanks of the two drive gears 37, 36 of the transfer cylinder 24 and of the form cylinder 25 rest against each other and, furthermore, the non-driving tooth flanks of the auxiliary gear 39 rest against the non-driving tooth flanks of the drive gear 36 of the form cylinder 35 of the associated printing couple 21, 22. As a result, the intermeshing, which is subject by nature to backlash between the two intermeshing drive gears 36, 37 of the transfer cylinder 24 and the form cylinder 25 in the area of each printing couple, can be kept free of backlash. So that the adjusting disk 40 in question can be rotated versus the drive gear 37, a cam 42 is assigned to the adjusting disk 40. Between the auxiliary gear 39 and the drive gear 37, a plain bearing is provided, especially a plain bearing made of plastic, to prevent the two components, which move only slightly with respect to each other, from rusting together.

The invention is not limited by the embodiments described above which are presented as examples only but can be modified in various ways within the scope of protection defined by the appended patent claims.

We claim:

1. A printing unit of a printing press, the printing unit having at least one printing couple, each said printing couple comprising:
a form cylinder, a transfer cylinder, and an inking couple, the transfer cylinder having a circumference which is a whole-number multiple of the circumference of the form cylinder;
an impression cylinder cooperating with the form cylinder to form a nip through which a substrate to be printed can be fed;
a drive connection between the transfer cylinder and the form cylinder, the drive connection between the transfer cylinder and the form cylinder comprising a drive gear assigned to the transfer cylinder and a drive gear assigned to the form cylinder; and
a drive connection comprising intermeshing drive gears between the transfer cylinder and the inking couple, the intermeshing drive gears between the transfer cylinder and the inking couple being arranged so that the drive connection between transfer cylinder and the inking couple is independent of the drive connection between the transfer cylinder and the form cylinder.

2. The printing unit of claim 1 wherein the intermeshing drive gears of each said printing couple comprise:
a drive gear assigned to the transfer cylinder;
a drive gear assigned to a roller of the inking couple; and
at least one intermediate gear connecting the drive gear assigned to the transfer cylinder to the drive gear assigned to a roller of the inking couple.

3. The printing unit of claim 2 wherein the drive gear assigned to the form cylinder meshes directly with the drive gear assigned to the transfer cylinder.

4. The printing unit of claim 3 wherein each said printing couple further comprises:
an auxiliary gear assigned to the drive gear of one of the transfer cylinder and the form cylinder;
an adjusting disk assigned to the drive gear of said one of the transfer cylinder and the form cylinder; and
at least one flexible element extending in the axial direction through the drive gear of said one of the transfer cylinder and the form cylinder, through the auxiliary disk, and through the adjusting disk, thereby connecting the auxiliary gear and the adjusting disk to the drive gear,
wherein the auxiliary gear can be rotated with respect to drive gear of said one of the transfer cylinder and the form cylinder by rotation of the adjusting disk so that the meshing of the drive gears is kept free of backlash.
